(19) United States
(12) Patent Application Publication
(10) Pub. No.: US 2007/0168955 A1
(43) Pub. Date: Jul. 19, 2007

(54) Scalable networked build automation

(75) Inventors: John W. Nicol, Redmond, WA (US); Paul M. Vickerman, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redwood, WA (US)

(21) Appl. No.: 11/259,772

(22) Filed: Oct. 27, 2005

(51) Int. Cl. G06F 9/44

(52) U.S. Cl. 717/120

(57) ABSTRACT

A scalable networked build automation system may include multiple users' workstations, multiple build machines, and an active build automation apparatus. In operation of an example implementation, a programmer checks-in coding changes from a user's workstation to the active build automation apparatus. When a new build is warranted based on the coding changes, the active build automation apparatus issues one or more build commands to a build machine. In response to the one or more build commands, the build machine performs build work. In another example implementation, a build process on a build machine is not running. Upon receipt of a build command from the active build automation apparatus, the build machine starts the build process.

### BACKGROUND

When a software program is being created, a programmer typically writes source code at a level that may be read and understood by other humans. The source code is then fed to a compiler. The compiler transforms the source code into an executable file. The executable file is usually in a machine language that can not be easily understood by humans but that can be quickly digested by a processor of a computer.

With a larger software program, many programmers and possibly many teams of many programmers work together to create the many code pieces that are used to ultimately produce the large software program. In more general terminology, the programmers create original files. The original files are then fed to a build system that manipulates them to produce build-result files. These build-result files are often capable of being directly consumed by a processing device.

To facilitate interaction between the many programmers and to ensure organization is maintained among the various original files as well as among different versions of the build-result files, a networked build organizer is often employed as part of a build system. An overall build system may include, for example, user workstations, the networked build organizer, and build machines. The networked build organizer is responsible for effecting significant coordination among the programmers, the original files created by the programmers, the workstations used by the programmers, the build-result files and different versions thereof, and the build machines that produce the build-result files from the original files.

### SUMMARY

A scalable networked build automation system may include multiple users' workstations, multiple build machines, and an active build automation apparatus. In operation of an example implementation, a programmer checks-in coding changes from a user's workstation to the active build automation apparatus. When a new build is warranted based on the coding changes, the active build automation apparatus issues one or more build commands to a build machine. In response to the one or more build commands, the build machine performs build work. In another example implementation, a build process on a build machine is not running. Upon receipt of a build command from the active build automation apparatus, the build machine starts the build process.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, etc. implementations are described herein.

### BRIEF DESCRIPTION OF THE DRAWINGS

The same numbers are used throughout the drawings to reference like and/or corresponding aspects, features, and components.

FIG. 1 is a block diagram of a decentralized approach to a build system in which multiple build machines have an active role.

FIG. 2 is a block diagram of an example centralized approach to a build system in which a build automation apparatus has an active role.

FIG. 3 is a block diagram of an example device that may be employed in a centralized approach to implementing a build system.

FIG. 4 is block diagram of the centralized approach to a build system as illustrated in FIG. 2 in which an example build automation apparatus is realized as a source controller, a change processor, and a build requester.

FIG. 5 is a flow diagram that illustrates an example of a method for operating a build system having an active build automation apparatus.

### DETAILED DESCRIPTION

### Introduction

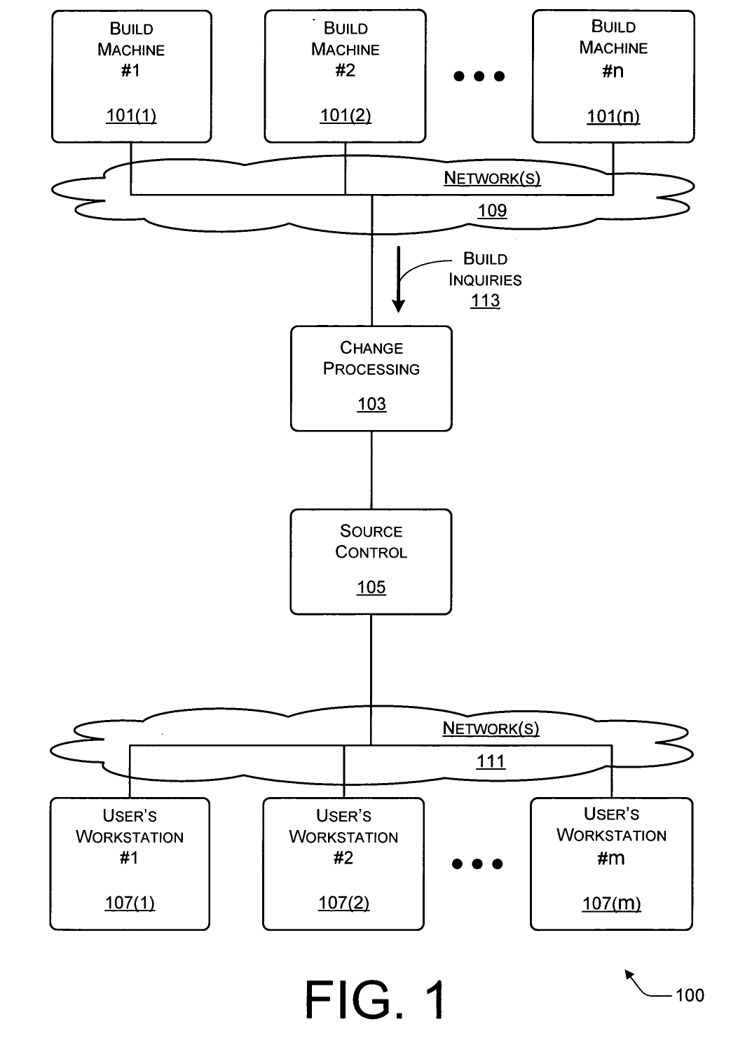

FIG. 1 is a block diagram of a decentralized approach to a build system 100 in which multiple build machines 101 have an active role. As illustrated, build system 100 includes multiple build machines 101, change processing 103, source control 105, multiple users' workstations 107, and one or more networks 109 and 111. Build system 100 is considered decentralized and build machines 101 are considered to have an active role because the timing and occurrence of build manipulations that produce build-result files are driven by build machines 101.

More specifically in build system 100, “n” build machines 101(1), 101(2) . . . 101(n) are shown communicating with change processing 103 over one or more networks 109. Also, “m” user's workstations 107(1), 107(2) . . . 107(m) are shown communicating with source control 105 over one or more networks 111. Change processing 103 is in communication with source control 105.

Although shown in separate blocks, change processing 103 and source control 105 may be co-located at a single machine or at a machine cluster. Although shown as separate network infrastructures, network(s) 109 and network(s) 111 may be the same network, or they may be overlapping networks.

In operation, programmers make changes to original file coding at users' workstations 107. These changes are sent from users' workstations 107 to source control 105. Source control 105 records these changes. The recorded changes are passed from source control 105 to change processing 103. The recorded changes may be passed actively or in response to polling. In other words, depending on the implementation of source control 105 (as well as change processing 103), the recorded changes may be proactively pushed to change processing 103, or the recorded changes may be sent to change processing 103 after receiving a polling request from change processing 103.

Generally, change processing 103 determines if a build is advisable based on the recorded changes. Change processing 103 also typically determines which subset of build machines 101 are to be used to produce the new build files resulting from incorporating the recorded changes.

Meanwhile, build machines 101 poll (e.g., periodically) change processing 103 as indicated by build inquiries 113. Build inquiries 113 are requests from build machines 101 for additional build work. A build inquiry 113 is sent from a build machine 101 at regular intervals, whenever a build machine 101 completes a build task, when a build machine 101 empties a build task queue, some combination thereof, and so forth. If there is build work for an inquiring build machine 101, change processing 103 sends a build task to the inquiring build machine 101.

If, on the other hand, there is no build work for a particular inquiring build machine 101, networks 109 are unnecessarily used, and change processing 103 is unnecessarily interrupted. However, the polling of change processing 103 by build machines 101 with build inquiries 113 does provide some benefits. For example, the overall build system 100 is relatively easy to maintain because the polling processes may be shutdown (and also restarted) at will, including at regular intervals. Consequently, any upgrading of the build processes is facilitated because of the available downtime. Furthermore, stability problems associated with long-running applications are avoided by being able to shutdown the build processes.

Unfortunately, the drawbacks of having build machines 101 issue build inquiries 113 can outweigh the benefits, especially as the number of build machines 101 increases. In other words, the polling of the decentralized approach of build system 100 suffers from scalability problems. More precisely, polling scales linearly with the number of build machines 101. As the number of build machines 101 increases, both change processing 103 and network 109 are strained. This strain causes deadlocks, delays, and other problems.

To partially alleviate the strain, random delays can be introduced to the polling by build inquiries 113. Randomly issuing build inquiries 113 reduces the likelihood of congestion on network 109 and also reduces the probability of overloading change processing 103. However, introducing random delays into the polling by build machines 101 sacrifices build machine speed (and overall build system speed) for reliability.

A centralized approach to a build system in which the build machines are more passive can avoid the use of random delays and introduce a greater level of control over the overall build system. Example implementations for a centralized approach to build systems are described herein below.

### Scalable Networked Build Automation

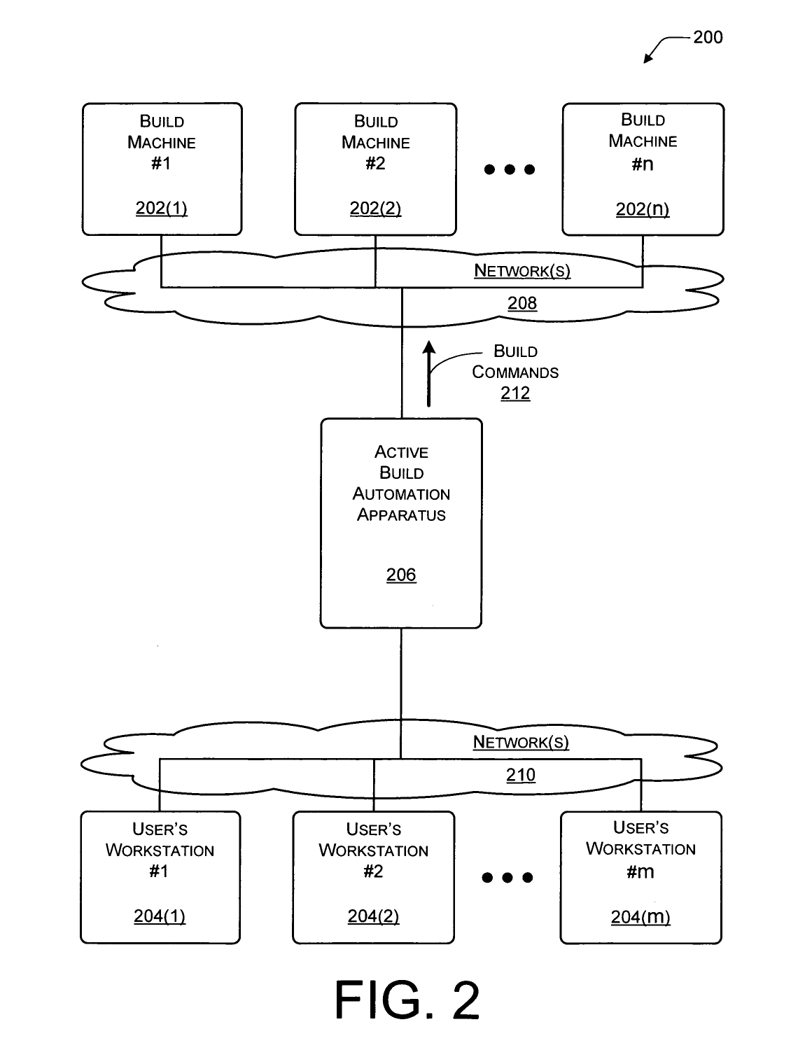

FIG. 2 is a block diagram of an example centralized approach to a build system 200 in which build automation apparatus 206 has an active role. As illustrated, build system 200 includes multiple build machines 202, multiple users' workstations 204, an active build automation apparatus 206, and one or more networks 208 and 210. Build system 200 may be considered to implement a relatively centralized approach, and build machines 202 may be considered to have a more passive role, because the timing and occurrence of build manipulations that produce build-result files are driven by active build automation apparatus 206. In effect, active build automation apparatus 206 pushes build work in the form of build tasks to build machines 202.

More specifically in build system 200, “m” user's workstations 204(1), 204(2) . . . 204(m) are shown communicating with active build automation apparatus 206 via one or more networks 210. Active build automation apparatus 206 is shown coupled to “n” build machines 202(1), 202(2) . . . 202(n) over one or more networks 208. In a described implementation, active build automation apparatus 206 is capable of orchestrating a networked build automation process by issuing build commands 212 to one or more build machines 202.

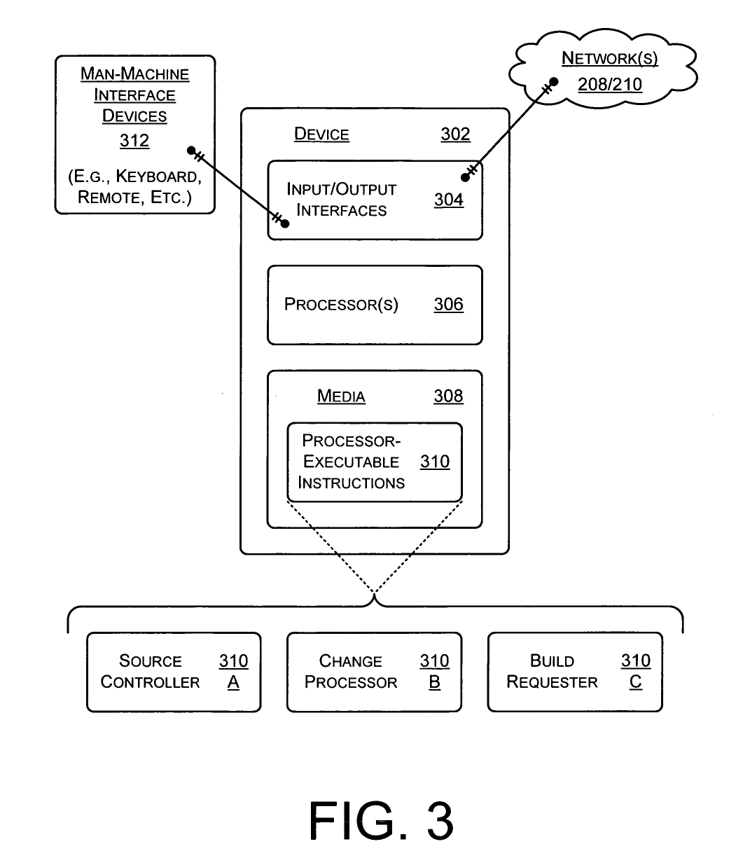

Although illustrated as a single monolithic block, active build automation apparatus 206 may be comprised of one or more devices. Examples of such devices include, but are not limited to, a computer, a workstation, a server, a mass memory storage device, a cluster of such devices, some combination thereof, and so forth. Active build automation apparatus 206 may also comprise one or more modules of processor-executable instructions. An example device having processor-executable instructions is described herein below with particular reference to FIG. 3.

Although each is shown as a single monolithic network architecture, network(s) 208 and network(s) 210 may each comprise multiple networks. Also, network(s) 208 and network(s) 210 may comprise the same network, may be comprised of different networks, may be comprised of overlapping networks, and so forth. Examples of network(s) 208 and 210 include, but are not limited to, an intranet, an ethernet, the internet, a telephone network, a cable network, a wireless or wired network, some combination thereof, and so forth.

In a described implementation, active build automation apparatus 206 is relatively active and build machines 202 are relatively passive. Active build automation apparatus 206 determines when it is appropriate to perform a build to create new build-result files based on changes in the original files. Responsive to a determination that it is appropriate to perform a new build, active build automation apparatus 206 sends one or more build commands 212 to at least one build machine 202. The one or more build commands 212 instruct the at least one build machine 202 to perform a build task.

Build machines 202, being relatively passive, do not poll active build automation apparatus 206 to inquire as to whether there is any build work available. Instead, build machines 202 await reception of one or more build commands 212. In one example implementation, build commands 212 may include sufficient build information for a build machine 202 to complete a build task. In another example implementation, a build machine 202 may request build information from active build automation apparatus 206 responsive to receipt of a build command 212. Other approaches to communication exchanges that occur between active build automation apparatus 206 and a build machine 202 after issuance of a build command 212 may alternatively be implemented.

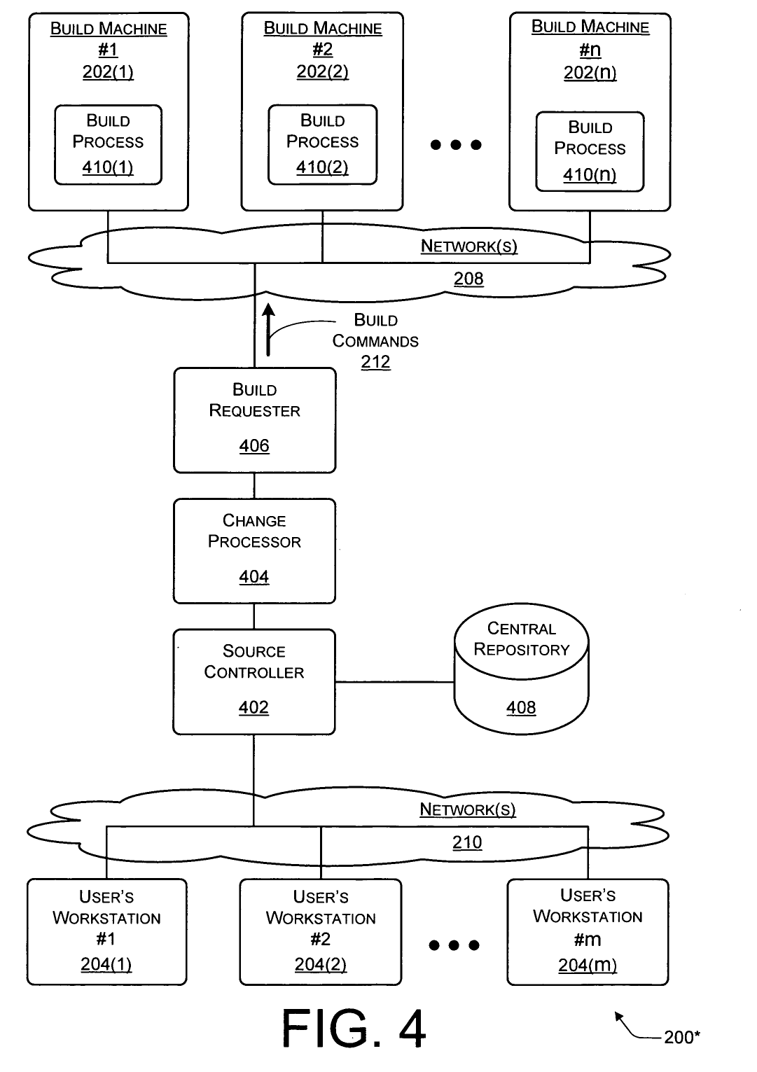

FIG. 3 is a block diagram of an example device 302 that may be employed in centralized approaches to implementing a build system such as those illustrated in FIGS. 2 and 4. For example, device 302 may be an example of a user's workstations 204, an active build automation apparatus 206, a build machine 202, and so forth. Device 302 may also be an example of an implementation of blocks 402-406 (of FIG. 4). For instance, device 302 may represent a server device, a storage device, a workstation or other general computer device, a transmission device, some combination thereof, and so forth. As illustrated, device 302 includes one or more input/output (I/O) interfaces 304, at least one processor 306, and one or more media 308, which include processor-executable instructions 310. Although not specifically illustrated, device 302 may also include other components.

In a described implementation of device 302, I/O interfaces 304 may include (i) a network interface for communicating across network(s) 208 and/or 210, (ii) a display device interface for displaying information on a display screen, (iii) one or more man-machine interfaces, and so forth. Examples of (i) network interfaces include a network card, a modem, one or more ports, and so forth. Examples of (ii) display device interfaces include a graphics driver, a graphics card, a hardware or software driver for a screen or monitor, and so forth. Examples of (iii) man-machine interfaces include those that communicate by wire or wirelessly to man-machine interface devices 312 (e.g., a keyboard, a mouse or other graphical pointing device, etc.).

Generally, processor 306 is capable of executing, performing, and/or otherwise effecting processor-executable instructions, such as processor-executable instructions 310. Media 308 is comprised of one or more processor-accessible media. In other words, media 308 may include processor-executable instructions 310 that are executable by processor 306 to effect the performance of functions by device 302.

Thus, realizations for scalable networked build automation may be described in the general context of processor-executable instructions. Generally, processor-executable instructions include routines, programs, applications, coding, modules, protocols, objects, interfaces, components, metadata and definitions thereof, data structures, etc. that perform and/or enable particular tasks and/or implement particular abstract data types. Processor-executable instructions may be located in separate storage media, executed by different processors, and/or propagated over or extant on various transmission media.

Processor(s) 306 may be implemented using any applicable processing-capable technology. Media 308 may be any available media that is included as part of and/or accessible by device 302. It includes volatile and non-volatile media, removable and non-removable media, and storage and transmission media (e.g., wireless or wired communication channels). For example, media 308 may include an array of disks for mass storage of both original and build-result files, random access memory (RAM) for storing instructions that are currently being executed, links on networks 208/210 for transmitting communications, and so forth. Processor-executable instructions 310 may also be stored on nonvolatile memory such as disk drives and flash memory.

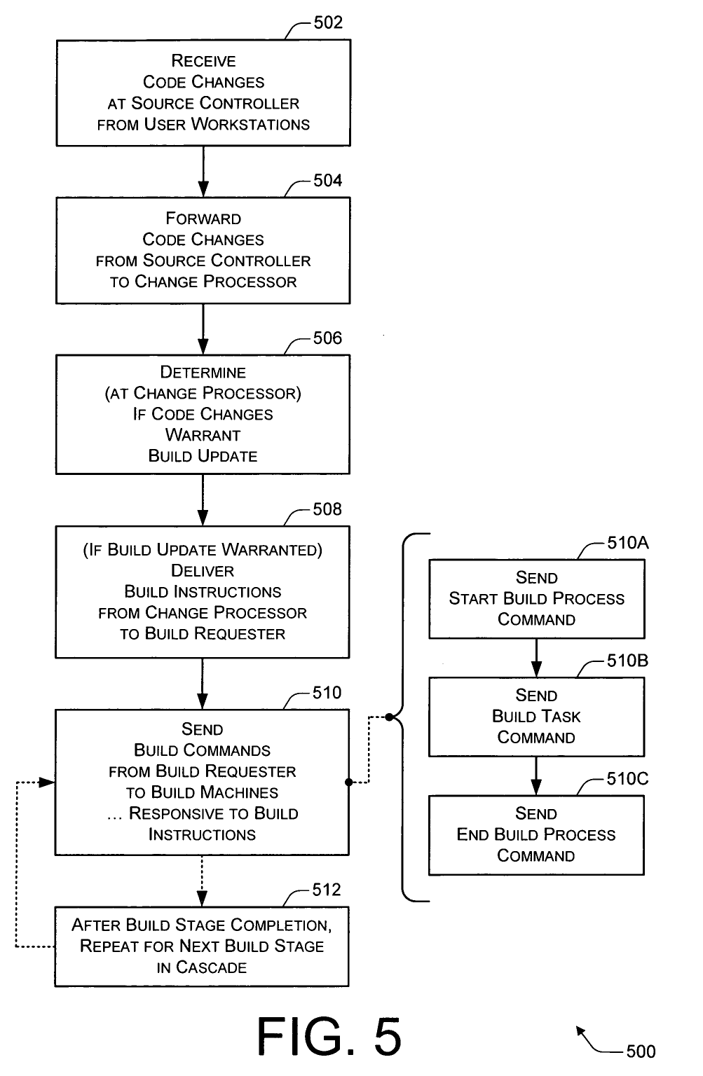

As illustrated, media 308 comprises at least processor-executable instructions 310. Generally, processor-executable instructions 310, when executed by processor 306, enable device 302 to perform the various functions described herein, including those actions that are illustrated in flow diagram 500 of FIG. 5. Specifically, but by way of example only, processor-executable instructions 310 may include a source controller 310A, a change processor 310B, and a build requester 310C.

The processor-executable instructions of source controller 310A are capable of performing source control functions. Example source control functions are described herein below with particular reference to source controller 402 of FIG. 4. The processor-executable instructions of change processor 310B are capable of performing change processing functions. Example change processing functions are described herein below with particular reference to change processor 404 of FIG. 4. The processor-executable instructions of build requester 310C are capable of performing build request functions, such as issuing build commands 212 to build machines 202. Example build request functions are described herein below with particular reference to build requester 406 of FIG. 4.

FIG. 4 is block diagram of the centralized approach to a build system 200* (similar to that illustrated in FIG. 2) in which an example build automation apparatus is realized as a source controller 402, a change processor 404, and a build requester 406. Build system 200* also includes a central repository 408 and multiple build processes 410. As illustrated, each build machine 202(1, 2 . . . n) includes at least one respective build process 410(1, 2 . . . n). For example, build machine 202(2) includes build process 410(2). Alternatively, individual build machines 202 may include multiple build processes 410 that are extant and executing on a single device.

Each of blocks 402, 404, and 406 may be implemented as a separate device 302 or cluster of devices 302. Alternatively, two or more of blocks 402, 404, and 406 may be implemented on a single device 302. By way of example only, source controller 402 and change processor 404 may be implemented on a first server device, and build requester 406 may be implemented on a second server device. Other physical architectures may alternatively be adopted.

In operation, programmers make changes to original file coding at users' workstations 204. These changes are sent from users' workstations 204 to source controller 402 over network 210 so as to “check in” the modified code.

In a described implementation, source controller 402 is adapted to ensure that each programmer that is coding at a user's workstation 204 is working on the same version of the program and/or coding portions thereof as the other programmers (i.e., version consistency control). Usually, this same version is the most recently built version. In operation, this version control involves cooperative communications across network 210.

Typically, source controller 402 is also responsible for maintaining a central repository 408 that stores different versions of the overall program and/or coding portions thereof. The central repository 408 may be co-located with source controller 402, change processor 404, and/or build requester 406. Alternatively, central repository 408 may be located separately, and/or it may be accessible by way of networks 208 or 210.

Source controller 402 may automatically forward recorded coding changes to change processor 404 for consideration as to whether a new build is warranted. Alternatively, change processor 404 may poll source controller 402 asking to receive any new recorded coding changes.

Change processor 404 is adapted to determine whether or not a new build is warranted based on the coding changes recorded by source controller 402. In other words, change processor 404 includes intelligence that is capable of deciding when it is time to perform a new build. For example, changes to documentation or comments generally do not warrant a new build. Significant changes to the functionality of a program do generally warrant a new build. When change processor 404 determines that a new build is warranted, change processor 404 notifies build requester 406 of the relevant recorded changes.

In response to notification that a new build is warranted and based on the recorded coding changes, build requester 406 issues one or more build commands 212 to at least one build machine 202. Build commands 212 precipitate or cause build processes 410 to perform a build. Build processes 410 are adapted to perform a build to manipulate (e.g., transform) original files (e.g., that have changes) into new build-result files.

Build requester 406 may send a build task to a particular build machine 202 after receiving an acknowledgement from the particular build machine 202 in response to the particular build machine 202 having received an initial build command 212. Alternatively, the particular build machine 202 may request build information for the build task in response to receiving the initial build command 212. Regardless, if a build queue (not explicitly shown) of a build process 410 is not empty, then the new build task is added to the build queue.

In a described implementation, build requester 406 targets a particular build machine 202 with each build command 212. The targeted build machine 202 may be selected using any of many possible approaches. For example, the targeted build machine 202 may be selected using a round robin or randomized algorithm. Alternatively, a large program may be divided into pieces termed projects. Each build machine 202 is then associated with at least one project. When a build command 212 is being issued for a given build task, it is sent to the build machine 202 that is associated with the project corresponding to the build task. A database may be maintained that associates one or more respective projects with respective assigned build machines 202.

Build processes 410 may be implemented at build machines 202 with any of a variety of approaches. For example, a build process 410 may be idled when its build queue is empty. Upon receipt of a build command 212, build machine 202 wakes up the resident build process 410. The awakened build process 410 may then respond to the received build command 212 and/or await additional build commands 212. However, this approach in which build processes 410 are continuously running does entail drawbacks. Example drawbacks include the difficulty of updating code that is currently being executed, the instability problems associated with long-running code, and so forth.

Consequently, an implementation described herein uses an alternative approach. When a build process 410 empties its build queue, the build processes 410 exits. More generally, instead of merely being idled, each build processes 410 ends when it is not performing build work. A build process 410 is ended when it self-concludes by exiting or when another entity terminates it.

Upon receipt of a build command 212, build machine 202 starts the resident build process 410 that had previously ended (or that had not yet been started since a most-recent reboot of build machine 202). The started build process 410 may then respond to the received build command 212 and/or await additional build commands 212. This ability can facilitate the creation of down periods for updating build processes 410 and can also reduce instability concerns associated with long-running code.

The ability of a build machine 202 to start a build process 410 may be enabled in a variety of manners. For example, an operating system (OS) running on a build machine 202 may be employed to start a build process 410. An example OS is the Microsoft® Windows® Operating System available from Microsoft® Corporation of Redmond, Wash. With a Windows® OS, the Scheduled Tasks feature may be used. Typically, scheduled tasks are set up to be started at certain times (e.g., once a day, upon boot-up, periodically, etc.) or upon the occurrence of certain events.

In a described implementation, a build process 410 is included in the scheduled tasks. However, no start time is scheduled. Instead, a build command 212 (e.g., an initial build command 212) instructs the OS to start the build process 410 that is present in the scheduled task listing. The starting may be immediate, or the initial build command 212 may specify a start time. By way of example only, a Windows® Management Interface (WMI) command may be employed to instruct the OS to start the build process 410.

Another example OS is the UNIX® OS. UNIX® offers a Remote Shell feature. An “rsh” or Remote Shell instruction enables an incoming message to cause the UNIX® OS to start a program. Thus, a build command 212 may include a UNIX® rsh instruction to start a build process 410. Other alternative operating systems and/or approaches may be used to enable build requester 406 to remotely start build processes 410 at build machines 202.

FIG. 5 is a flow diagram 500 that illustrates an example of a method for operating a build system having an active build automation apparatus. Flow diagram 500 includes five (5) “primary” blocks 502-510 and three (3) “secondary” blocks 510A-510C. There is also a block 512 representing an alternative implementation. Although the actions of flow diagram 500 may be performed in other environments and with a variety of hardware and software combinations, an active build automation apparatus 206 (of FIG. 2) that is implemented to have a source controller 310A/402, a change processor 310B/404, and a build requester 310C/406 (of FIGS. 3 and 4) is used in particular to illustrate certain aspects and examples of the method.

At block 502, code changes are received at a source controller from user workstations. For example, programmers may check-in code changes from users' workstations 204 to a source controller 310A/402. The changes may be recorded at a central repository 408.

At block 504, the code changes are forwarded from the source controller to a change processor. For example, the recorded code changes may be forwarded from source controller 310A/402 to a change processor 310B/404. The forwarding may be initiated by source controller 310A/402 or may occur responsive to polling by change processor 310B/404.

At block 506, it is determined (e.g., at the change processor) if the code changes warrant a build update. For example, change processor 310B/404 may analyze the recorded code changes to determine if they are of a nature and extent to warrant a new build. If a build update is warranted, then flow diagram 500 continues at block 508.

At block 508, build instructions are delivered from the change processor to a build requester. For example, build instructions that reflect the recorded code changes may be delivered to build requester 310C/406 from change processor 310B/404 (when a new build is warranted).

At block 510, one or more build commands are sent from the build requester to at least one build machine responsive to the build instructions. For example, build requester 406 may send one or more build commands 212 to at least one build machine 202 responsive to the build instructions. Receipt of the one or more build commands 212 at the build machine 202 precipitates a build process 410 to begin performing build work.

Build process 410 may be running and capable of directly receiving the initial build commands 212. However, in a described implementation, arrival of the one or more build commands 212 at the build machine 202 causes a build process 410 to be started. Once started, build process 410 is capable of completing build tasks within a build queue to which it is associated. Build process 410, upon being started, may be adapted to automatically request a build task if its build queue is empty. Alternatively, build process 410 may wait for a build task to be added to its build queue by build requester 406.

An example scenario regarding the content and effects of build commands 212 is described with particular reference to blocks 510A, 510B, and 510C. However, other implementations for build commands 212 may alternatively be employed. At block 510A, a start build process command is sent. For example, build requester 310C/406 may send a start build process command to (e.g., the OS of) a targeted build machine 202. In response, the targeted build machine 202 may start a build process 410 that is resident thereat.

At block 510B, a build task command is sent. For example, build requester 310C/406 may send a build task command to build process 410 at the targeted build machine 202. In response, the build task may be added to a build queue of build process 410. The build task includes build information (including any related parameters) reflecting at least the code changes. The build task may include sufficient information to enable build process 410 to complete a new build of at least the subject portion of a program.

At block 510C, an end build process command is sent. For example, build requester 310C/406 may send an end build process command to (e.g., the OS or the build process 410 of) the targeted build machine 202. This shuts down build process 410 by causing the OS to terminate it or by causing build process 410 to self-exit. Alternatively, this command may be omitted if build process 410 is adapted to self-exit upon completing a build task and/or emptying its build queue.

An alternative implementation is represented by block 512. At block 512, after a build stage is completed, the action(s) of block 510 are repeated for a subsequent build stage in a cascade of stages. Stages having “progenitor builds” and “descendant builds” may be cascaded. In other words, builds may trigger other builds. For example, the output of a build A may be used in another build B, both of which are triggered by the same recorded code changes. In such an example scenario, build B is triggered after build A has been completed because build B relies on the build-results from build A.

With reference to flow diagram 500, block 510 may be realized by sending build commands from the build requester to the build machines in a Group A responsive to the build instructions. After the build work for Group A is completed and build-result files for stage A are created (as illustrated by block 512), the action(s) of block 510 are repeated. In subsequent iterative stages of the build cascade, block 510 may be realized by sending build commands from the build requester to the build machines in a Group B (or a Group C, or a Group D, etc.) responsive to the build instructions.

The devices, actions, aspects, features, functions, procedures, modules, data structures, components, etc. of FIGS. 2-5 are illustrated in diagrams that are divided into multiple blocks. However, the order, interconnections, interrelationships, layout, etc. in which FIGS. 2-5 are described and/or shown are not intended to be construed as a limitation, and any number of the blocks can be modified, combined, rearranged, augmented, omitted, etc. in any manner to implement one or more systems, methods, devices, procedures, media, apparatuses, APIs, arrangements, etc. for scalable networked build automation.

Although systems, media, devices, methods, procedures, apparatuses, techniques, schemes, approaches, procedures, arrangements, and other implementations have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. A method comprising:
determining if code changes warrant a build update;
producing build instructions if the code changes are determined to warrant a build update; and
sending one or more build commands from a build automation apparatus to at least one build machine responsive to the build instructions;
wherein the sending is performed without receiving a build inquiry at the build automation apparatus from the at least one build machine.

2. The method as recited in claim 1, further comprising:
receiving the code changes at the build automation apparatus from a workstation operated by a programmer.

3. The method as recited in claim 1, wherein the one or more build commands include the build instructions, and the build instructions comprise build information that enables the at least one build machine to perform a build update for the code changes.

4. The method as recited in claim 1, further comprising:
receiving the one or more build commands at the at least one build machine; and
starting a build process at the at least one build machine responsive to the receiving of the one or more build commands.

5. The method as recited in claim 4, wherein the one or more build commands includes an operating system instruction; and
wherein the starting comprises:
starting, by an operating system, the build process responsive to the operating system instruction.

6. The method as recited in claim 5, wherein the operating system comprises a unix-type operating system, and the operating system instruction comprises a remote shell (rsh) instruction.

7. The method as recited in claim 5, wherein the operating system instruction comprises a Windows® Management Interface (WMI) command that instructs the operating system to start the build process.

8. The method as recited in claim 5, wherein the operating system instruction comprises a command to start the build process from a list of scheduled tasks.

9. A build automation apparatus comprising:
a change processor that is capable of determining if code changes warrant a build update; and
a build requester that is adapted to issue one or more build commands to at least one build machine when the change processor determines that the code changes warrant a build update;
wherein the one or more build commands are issued by the build requester in response to a build update determination by the change processor without receiving a build inquiry at the build automation apparatus from the at least one build machine.

10. The build automation apparatus as recited in claim 9, further comprising:
a source controller that is capable of receiving the code changes from a user's workstation, the source controller adapted to institute version consistency control across multiple users' workstations.

11. The build automation apparatus as recited in claim 9, wherein the one or more build commands include an instruction for the at least one build machine to start a build process that is resident at the at least one build machine.

12. The build automation apparatus as recited in claim 9, wherein the one or more build commands include build instructions, and the build instructions comprise build information that enables the at least one build machine to perform the build update for the code changes.

13. The build automation apparatus as recited in claim 9, wherein the build requester receives a request for build instructions from the at least one build machine after issuing the one or more build commands to the at least one build machine; and wherein the build requester is adapted to respond to the request for build instructions by sending build instructions to the at least one build machine.

14. A build system comprising:
a build machine that is capable of performing build tasks to manipulate original files into build-result files; and
a build automation apparatus that is adapted to issue one or more build commands to the build machine when it is determined that code changes warrant a build update;
wherein the one or more build commands are issued by the build automation apparatus in response to a determination that the code changes warrant a build update and without receiving a build inquiry at the build automation apparatus from the build machine.

15. The build system as recited in claim 14, further comprising at least one of:
multiple build machines that are capable of performing build tasks to manipulate original files into build-result files; or
a workstation used by a programmer, wherein the programmer can check-in the code changes to the build automation apparatus from the workstation.

16. The build system as recited in claim 14, wherein the build automation apparatus is capable of determining if the code changes warrant the build update; and wherein the build automation apparatus is further capable of receiving the code changes from a user's workstation and is further adapted to institute version consistency control across multiple users' workstations.

17. The build system as recited in claim 14, wherein the build machine includes a build process; and wherein the build machine is adapted to start the build process upon receipt of the one or more build commands.

18. The build system as recited in claim 17, wherein the build process is adapted to process build tasks in a build queue until the build queue is emptied.

19. The build system as recited in claim 18, wherein the build process ends after the build queue is emptied.

20. The build system as recited in claim 14, wherein the build machine includes a build process; and wherein the build process is running and capable of receiving an initial build command of the one or more build commands.
